(19) United States
(12) Patent Application Publication
(10) Pub. No.: US 2025/0302004 A1
(43) Pub. Date: Oct. 2, 2025

(54) TETHER DEVICE AND METHODS OF USE

(71) Applicant: Laura Ann Saylor, Walkerton, IN (US)

(72) Inventor: Laura Ann Saylor, Walkerton, IN (US)

(21) Appl. No.: 19/225,948

(22) Filed: Jun. 2, 2025

Related U.S. Application Data
(60) Provisional application No. 63/731,097, filed on Apr. 1, 2024.

(51) Int. Cl. A01K 1/06

(52) U.S. Cl. CPC A01K 1/06

(57) ABSTRACT

Tether device and methods of use. The tether device includes a coiled cable having a collapsed length in an untensioned state, a fully uncoiled length, and a hanging length to which the cable extends under a weight thereof when the cable is supported from a first end thereof. The fully uncoiled length is about two meters or less and the hanging length is about 0.6 meter or less. The tether device further includes a first and second swivel couplings coupled to the first end of the cable and a second end of the cable. The second swivel coupling has a base and a sleeve that translates on the base between a lock position and a release position. In the lock position, the second swivel coupling is closed as a result of a latch of a swivel leg being retained by the sleeve. In the release position, the second swivel coupling is open as a result of the latch of the swivel leg being released from the sleeve and the swivel leg being free to pivot.

### CROSS-REFERENCE TO RELATED APPLICATIONS

This application claims the benefit of provisional U.S. Patent Application No. 63/731,097 filed Apr. 1, 2024, the contents of which are incorporated herein by reference.

### BACKGROUND OF THE INVENTION

The invention relates generally to devices and methods for limiting the movement of animals, and more particularly to tethers and methods for tethering large animals, especially horses.

Horses are often transported by trailers to different locations, such as rodeos, camp sites, riding trails, etc. Once off-loaded from a trailer, it is often necessary to secure the horse to a structure, such as a hitch rail, picket-line, wash rack, crosstie, tie stall, or the trailer itself. A tether or other suitable flexible cord is commonly used to secure (tether) a horse to such structures. While tethered, it is common for the horse to be fed and watered, such as by giving the horse access to a feeder and water bucket sitting on the ground or allowing the horse to graze on grass at its feet. For this purpose, the tether must be sufficiently long for the horse to place its mouth at or close to the ground. A hazard that can arise is if the tether is sufficiently long for the horse to step on or over the tether, in which case the horse can become tangled in the tether with the horse possibly falling. Other hazards can arise if the tether becomes free of the structure to which it was tied, in which case the tether will drag on the ground and again pose the risk of becoming tangled with the horse's legs or obstacles along the horse's path.

In view of the above, it would be desirable if a device and method were available that could reduce the risk of a tethered horse (or similarly-sized animal) becoming entangled in the tether.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, tethers and methods for tethering large animals, especially horses.

According to a nonlimiting aspect, a tether device includes a coiled cable having first and second ends. The coiled cable being coiled so as to have, in an untensioned state, an outer coil diameter, an inner coil diameter, and a collapsed length, the coiled cable having a fully uncoiled length and a hanging length to which the coiled cable extends under a weight thereof when the coiled cable is supported from the first end, the fully uncoiled length being about two meters or less and the hanging length being about 0.6 meter or less. The tether device further includes a first swivel coupling coupled to the first end of the coiled cable, and a second swivel coupling coupled to the second end of the coiled cable. The second swivel coupling has a base, first and second arms extending side-by-side from the base, a swivel leg pivotably coupled to distal ends of the first and second arms, a latch extending from a distal end of the swivel leg, and a sleeve that translates on the base between a lock position proximate the first and second arms and the swivel leg and a release position farther from the first and second arms and the swivel leg. In the lock position, the second swivel coupling is closed as a result of the latch of the swivel leg being retained by the sleeve and the swivel leg being prevented from pivoting relative to the first and second arms. In the release position, the second swivel coupling is open as a result of the latch of the swivel leg being released from the sleeve and the swivel leg being free to pivot relative to the first and second arms.

According to another nonlimiting aspect, a method of tethering a horse with the tether device includes coupling the first swivel coupling to a structure at an elevation above ground surface, and coupling the second swivel coupling to a bridle on the horse.

Technical aspects of tether devices and methods as described above preferably include the ability to reduce the risk of a tethered horse (or similarly-sized animal) becoming entangled while tethered.

These and other aspects, arrangements, features, and/or technical effects will become apparent upon detailed inspection of the figures and the following description.

### BRIEF DESCRIPTION OF THE DRAWINGS

FIGS. 1 and 2 depict two views of a tether device in accordance with a nonlimiting embodiment of the invention.

FIG. 3 is a side view of a coiled cable of the tether device of FIGS. 1 and 2.

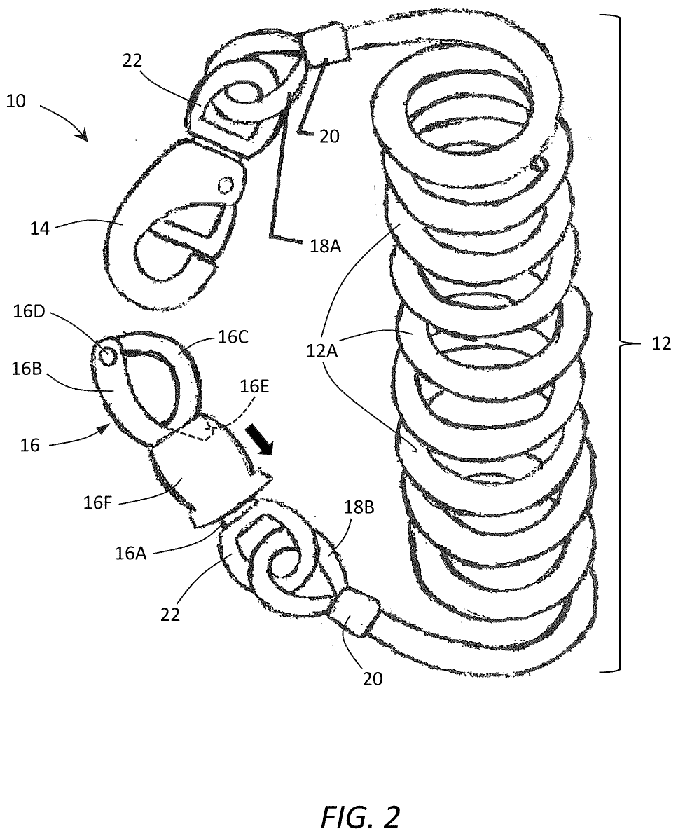

FIG. 4 is a plan view of a single coil of the coiled cable of FIGS. 1 through 3.

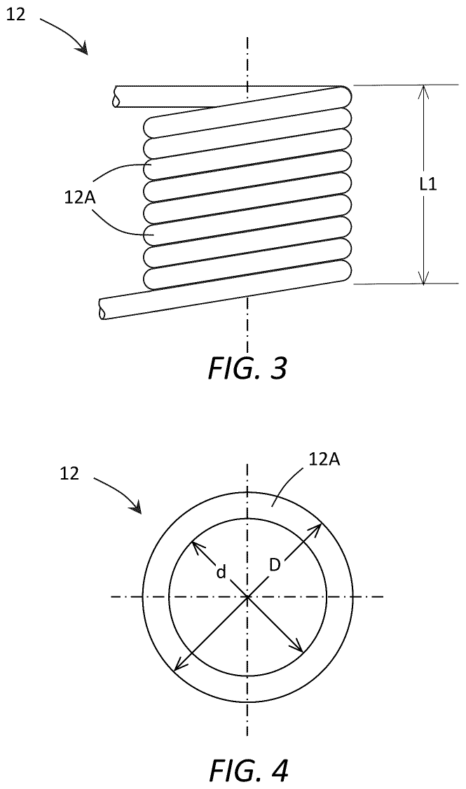

FIG. 5 represents the coiled cable having a hanging length in response to the tether device being hung from one end (not shown) of the device.

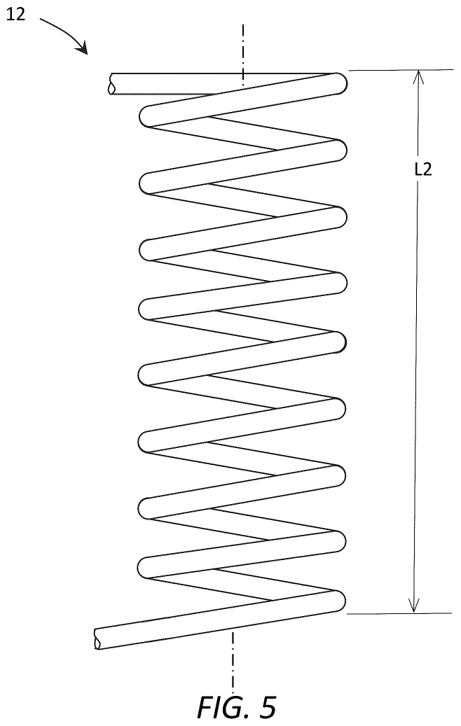

### DETAILED DESCRIPTION OF THE INVENTION

The intended purpose of the following detailed description of the invention and the phraseology and terminology employed therein is to describe one or more nonlimiting embodiments of the invention, and to describe certain but not all aspects of what is depicted in the drawings, including the embodiment(s) to which the drawings relate. The following detailed description also identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

Although the invention will be described hereinafter in reference to a tether device particularly well-suited for tethering a horse, it will be appreciated that the teachings of the invention are also generally applicable to tethering other animals of a similar size, for example, cattle.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to tether device as represented in the drawings. All such relative terms are useful to describe the illustrated embodiment but should not be otherwise interpreted as limiting the scope of the invention.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

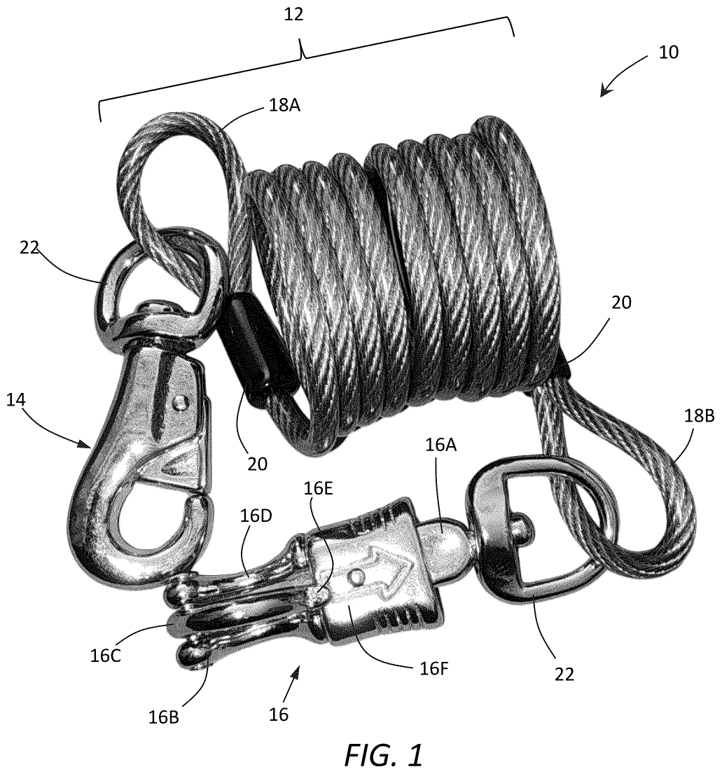

The drawings represent a tether device 10 as including a coiled cable 12 having first and second ends 18A and 18B. The coiled cable 12 is shown in FIG. 1 as formed by a braided steel cable enclosed in a protective sheath, though other configurations are foreseeable and within the scope of the invention. The coiled cable 12 has multiple coils 12A (nine as represented in the drawings) and is adapted to extend between an untensioned (free) state that the cable 12 acquires when not subjected to any tension along its length. In the untensioned state, the cable 12 has an outer coil diameter D, an inner coil diameter d, and a fully collapsed length L1. The coiled cable 12 is adapted to have a hanging length L2 to which the coiled cable 12 extends under its own weight (i.e., no extraneous tension is imposed along the length of the cable 12) when the cable 12 is supported from its first end 18A, i.e., on a structure, such that the second end 18B dangles free from any extraneous forces. It should be apparent from the drawings that the cable 12 also has a fully uncoiled length (not shown) that results from the cable 12 being completely extended so as to be substantially straight and at its maximum length.

The tether device 10 is adapted to tether a horse to a structure, such as a trailer, a hitch rail, a picket-line, a wash rack, a crosstie, or a tie stall, by coupling a first swivel coupling 14 of the device 10 to a structure at an elevation above ground surface, and coupling a second swivel coupling 16 of the device 10 to a bridle on the horse. The first swivel coupling 14 is coupled to the first end 18A of the coiled cable 12, and the second swivel coupling 16 is coupled to the second end 18B of the coiled cable 12. In the embodiment shown, each of the swivel couplings 14 and 16 includes a swiveling eyelet 22 that is secured to the coiled cable 12 by a loop formed in the cable 12 with crimps 20. Aside from having a swivel capability that enables the first swivel coupling 14 to freely rotate about an axis thereof, the first swivel coupling 14 can be of any suitable design capable of withstanding the loads imposed by a horse pulling on the tether device 10.

The second swivel coupling 16 has a base 16A to which its swiveling eyelet 22 is coupled so that the second swivel coupling 16 also has a swivel capability that enables the second swivel coupling 16 to freely rotate about an axis of the base 16A The second swivel coupling 16 has first and second arms 16B that extend side-by-side from the base 16A, and a swivel leg 16C disposed between the first and second arms 16B and pivotably coupled by a pivot pin 16D to distal ends of the first and second arms 16B. A latch 16E extends from a distal end of the swivel leg 16C, and a sleeve 16F is mounted on the base 16A so that the sleeve 16F is able to translate on the base 16A between a lock position (FIG. 2) proximate the first and second arms 16B and the swivel leg 16C and a release position (FIG. 1) in which the sleeve 16F is farther from the first and second arms 16B and the swivel leg 16C. In the lock position, the second swivel coupling 16 is closed as a result of the latch 16E of the swivel leg 16C being retained by and within the sleeve 16F, such that the swivel leg 16C is prevented from pivoting relative to the first and second arms 16B. In the release position, the second swivel coupling 16 is open as a result of the latch 16E of the swivel leg 16C being released from the sleeve 16F and the swivel leg 16C being free to pivot relative to the first and second arms 16B. The closed position of the second swivel coupling 16 enables the coupling 16 to capture a loop or ring-like feature, such as a ring on a harness, whereas the open position of the coupling 16 serves to release the captured feature. The ability to translate the sleeve 16F away from the arms 16B and leg 16C to open the swivel coupling 16 makes it possible to open the coupling 16 even when a horse is straining on the tether device 10.

For purposes of safely tethering a horse, the fully uncoiled length of the coiled cable 12 is preferably about two meters or less, optionally about one meter or less. At a length of not more than two meters, a horse tethered with the device 10 is free to feed and drink from containers placed on the ground adjacent the structure to which the first swivel coupling 14 is coupled, but then the cable 12 recoils to a shorter length when the horse raises its head or otherwise moves closer to the structure so that the cable 12 cannot become entangled in the legs of the horse. The hanging length L2 is preferably less than one meter, more preferably about 0.6 meter or less. At such lengths, the tether device 10 can be uncoupled (intentionally or unintentionally) at the first swivel coupling 14 from the structure and allowed to hang freely from the horse's bridle without the device 10 hanging so low on the horse as to become entangled or otherwise pose a risk of harm to the horse's legs as the horse is walking.

As previously noted above, though the foregoing detailed description describes certain aspects of one or more particular embodiments of the invention, alternatives could be adopted by one skilled in the art. For example, the tether device 10 and its components could differ in appearance and construction from the embodiment described herein and shown in the drawings, functions of certain components of the tether device 10 could be performed by components of different construction but capable of a similar (though not necessarily equivalent) function, and various materials could be used in the fabrication of the tether device 0 and/or its components. As such, and again as was previously noted, it should be understood that the invention is not necessarily limited to any particular embodiment described herein or illustrated in the drawings.

1. A tether device comprising:
a coiled cable having first and second ends, the coiled cable being coiled so as to have, in an untensioned state, an outer coil diameter, an inner coil diameter, and a collapsed length, the coiled cable having a fully uncoiled length and a hanging length to which the coiled cable extends under a weight thereof when the coiled cable is supported from the first end, the fully uncoiled length being about two meters or less and the hanging length being about 0.6 meter or less;
a first swivel coupling coupled to the first end of the coiled cable; and
a second swivel coupling coupled to the second end of the coiled cable, the second swivel coupling having a base, first and second arms extending side-by-side from the base, a swivel leg pivotably coupled to distal ends of the first and second arms, a latch extending from a distal end of the swivel leg, and a sleeve that translates on the base between a lock position proximate the first and second arms and the swivel leg and a release position farther from the first and second arms and the swivel leg, wherein in the lock position the second swivel coupling is closed as a result of the latch of the swivel leg being retained by the sleeve and the swivel leg being prevented from pivoting relative to the first and second arms, and in the release position the second swivel coupling is open as a result of the latch of the swivel leg being released from the sleeve and the swivel leg being free to pivot relative to the first and second arms.

2. A method of tethering a horse with the tether device of claim 1, the method comprising:
coupling the first swivel coupling to a structure at an elevation above ground surface; and
coupling the second swivel coupling to a bridle on the horse.
